(19) United States
(12) Patent Application Publication
(10) Pub. No.: US 2025/0178247 A1
(43) Pub. Date: Jun. 5, 2025

(54) CELLULOSE-BASED PACKAGING COMPONENT AND METHOD FOR MANUFACTURING THE COMPONENT

(71) Applicant: SACMI COOPERATIVA MECCANICI IMOLA SOCIETA' COOPERATIVA, IMOLA (BOLOGNA) (IT)

(72) Inventors: FABRIZIO PUCCI, CASTEL GUELFO DI BOLOGNA (BOLOGNA) (IT); FIORENZO PARRINELLO, MEDICINA (BOLOGNA) (IT); GIOVANNI MAZZOTTI, BOLOGNA (IT); ELEONORA BALDUCCI, MONDOLFO (PESARO E URBINO) (IT)

(21) Appl. No.: 18/832,302

(22) PCT Filed: Jan. 25, 2023
(86) PCT No.: PCT/IB2023/050629

§ 371 Date: Jul. 23, 2024

(30) Foreign Application Priority Data
Jan. 25, 2022 (IT) 102022000001163

(51) Int. Cl. B29C 43/00; B29C 43/02; B29K 1/00; B29K 501/00; B29L 31/00; B29L 31/56; B65D 1/02; B65D 41/32; B65D 43/02

(52) U.S. Cl. CPC B29C 43/003; B29C 43/027; B65D 1/0207; B65D 41/32; B65D 43/0212; B29K 2001/00; B29K 2501/00; B29K 2995/0063; B29L 2031/565; B29L 2031/7158; B65D 2543/00305

(57) ABSTRACT

A moulded packaging component is made with a material which contains a quantity of cellulose equal to at least 80% by weight. The moulded package component has an average density greater than or equal to 0.8 g/cm³.

The invention relates to a packaging component made with a material which comprises a significant quantity of cellulose. The packaging component according to the invention may in particular be a cap, a lid, a container, a container neck or other item.

The invention also relates to a method for making a cellulose-based packaging component.

For reasons linked to environmental protection, the use of natural and renewable materials is desirable, for example cellulose-based materials, for making packaging components. Indeed, such materials are much less polluting and easier to dispose of than synthetic polymers which are currently widely used in the packaging sector.

In order to make objects with cellulose-based materials, use is made of raw materials, for example in the form of powder or fluff, which have a very low initial density. When these raw materials are pressed to obtain the desired object, it is difficult to obtain uniform compaction and a suitable degree of compaction. Consequently, objects are obtained which may have non-optimal mechanical properties, for example relatively low mechanical strength or high deformability.

This means that the current objects made with cellulose-based materials are unsuitable for some uses in the packaging sector, for example they are unsuitable for use as caps or other components of containers, in particular if the latter contain pressurised liquids. Cellulose-based materials may also be unsuitable for making threaded components, since they may give rise to threads which are not very strong, which deform during use.

More generally, when using cellulose-based materials it is difficult to obtain packaging components, having a three-dimensional shape, which have good mechanical properties.

An object of the invention is to improve the packaging components made with a material containing a significant quantity of cellulose.

A further object is to provide a packaging component containing a significant quantity of cellulose, which has good mechanical properties.

Another object is to provide a packaging component made with a material containing a significant quantity of cellulose, which is capable of providing good performance even when it is used to package pressurised substances. In a first aspect of the invention, there is provided a moulded packaging component made with a material which contains a quantity of cellulose equal to at least 80% by weight, the packaging component having an average density greater than or equal to 0.8 g/cm³.

Owing to the invention, it is possible to obtain a packaging component made with an eco-friendly material, having a low environmental impact, which can easily be recycled and/or disposed of.

The packaging component according to the invention has a relatively high average density, which gives it good mechanical properties, in particular good mechanical strength and dimensional stability. Owing to the good mechanical properties, the packaging component can be deformed only with some difficulty. That makes packaging component according to the invention also suitable for uses in which some ability to withstand mechanical stresses is required.

Owing to the good mechanical properties of the packaging component according to the invention, packaging components may be designed having a relatively small thickness, without jeopardizing substantially the performance of the packaging components if compared to the prior art. Consequently, the weight of the packaging component may be kept low or even decreased.

Furthermore, packaging components having a relatively high density generally have smooth surfaces, i.e. scarcely porous surfaces. Treatments can be successfully applied on those surfaces which are aimed at changing the surface properties of the packaging component, for example aimed at increasing water resistance or to give particular functional properties to the moulded component.

The packaging component may comprise other ingredients in addition to cellulose, for example up to 10% synthetic polymers.

The packaging component may comprise up to 10% additives, for example comprising substances suitable for increasing the density obtained after compaction of the starting material, or substances suitable for improving particular types of performance of the packaging component, such as barrier properties against liquids or gases, or other performance.

In an embodiment, the packaging component may comprise a first portion of wall, and a second portion of wall, which surrounds the first portion of wall and extends around an axis.

The second portion of wall may be arranged in a peripheral region of the packaging component or in an inner region of the packaging component, in which case the second portion of wall is surrounded by a further portion of wall.

In the first portion of wall, the packaging component may have an average density greater than or equal to 0.8 g/cm³.

In the second portion of wall, the packaging component may have an average density greater than or equal to 0.8 g/cm³.

The second portion of wall may have an inclination different from that of the first portion of wall. For example, the second portion of wall may be arranged substantially vertically, whilst the first portion of wall may be arranged substantially horizontally. More generally, in a cross-section in a plane which contains said axis, the second portion of wall may form an angle of less than or equal to 45° with said axis.

The packaging component may have a concave shape. In this case, the first portion of wall may be a transversal wall, which extends transversally, for example perpendicularly to the axis. The second portion of wall may be a lateral wall, which projects from the first portion of wall.

The transversal wall may be an end wall which closes one end of the lateral wall.

An example of a packaging component having a concave shape is a cap for a container, or a container.

In an embodiment, the packaging component may be a neck for a container. In another embodiment, the packaging component may be a lid, for example a lid which is not flat usable for closing a paper or plastic cup.

The packaging component may be obtained by compression moulding. In a second aspect of the invention, there is provided a method for obtaining a packaging component, comprising the steps of:
inserting a material containing cellulose into a mould;
pressing the material containing cellulose in the mould;
extracting from the mould the formed packaging component, said packaging component comprising a quantity of cellulose equal to at least 80% by weight and having an average density greater than or equal to 0.8 g/cm³.

Owing to the second aspect of the invention, it is possible to obtain a packaging component having good mechanical properties which can be successfully used in the packaging of many types of materials.

The material containing cellulose that is inserted into the mould, i.e. the starting material, may be in a substantially dry state, for example in the form of powder, or fluff, or airlaid.

In an embodiment, that material can be pressed without adding high quantities of water.

This allows to keep limited the energy consumption of the method according to the second aspect of the invention, since it is no longer necessary to evacuate high quantities of water through evaporation. The amount of heat that needs to be supplied to the material containing cellulose may therefore be reduced.

The step of pressing the material containing cellulose in the mould involves an increase in density of the material containing cellulose.

In other words, density of the material containing cellulose is increased during pressing.

In an embodiment, the material containing cellulose that is inserted into the mould may have a density between 0.01 g/cm³ and 0.3 g/cm³, for example between 0.05 g/cm³ an 0.2 g/cm³.

The material containing cellulose has therefore, before the step of pressing, a relatively low density, which makes easier to fill regions of the mould having even a complicated geometry and obtain objects having a concave shape.

During the step of pressing, there is provided increasing the density of the material containing cellulose by at least 2.5 times.

In an embodiment, the density of the material containing cellulose may be increased by at least 80 times during pressing.

It is thus possible to obtain a moulded object having a relatively high density and hence having good mechanical properties.

The packaging material is obtained by compacting the material containing cellulose, without removing significant quantities of water, which results in packaging components having a good quality with limited energy consumption.

In an embodiment, the packaging component has a concave shape and comprises a lateral wall extending about an axis and a transversal wall extending transversally to the axis, the step of pressing comprising applying an axial pressure to the material containing cellulose, the axial pressure being directed in a direction parallel to the axis and being applied by moving two opposed mould parts relative to each other in order to form the transversal wall, so as to obtain an average density greater than, or equal to, 0.8 g/cm³ in the transversal wall of the packaging component, the step of pressing further comprising applying a transversal pressure transversally to the axis to the material containing cellulose, the transversal pressure being applied by moving a plurality of sectors of the mould, the sectors forming a surface of the lateral wall, so as to obtain an average density greater than, or equal to, 0.8 g/cm³ in the lateral wall of the packaging component.

The invention can be better understood and implemented with reference to the accompanying drawings, which illustrate several example, non-limiting embodiments of it, in which:

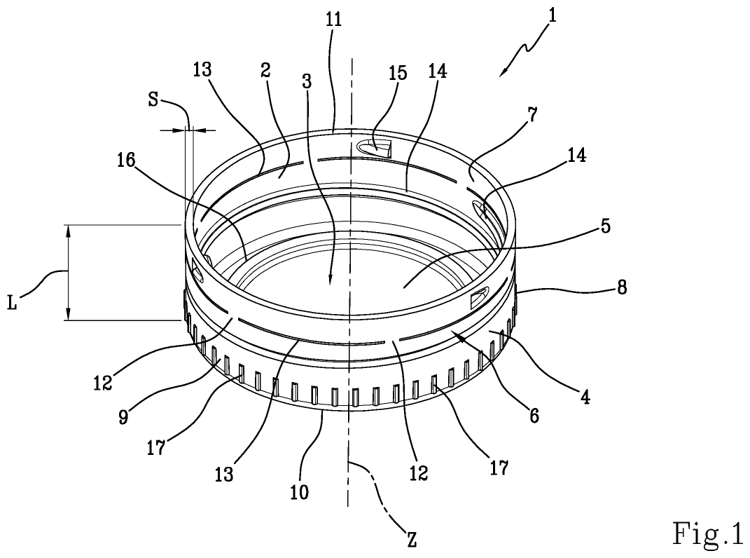

FIG. 1 is a perspective view showing a packaging component shaped like a threaded cap;

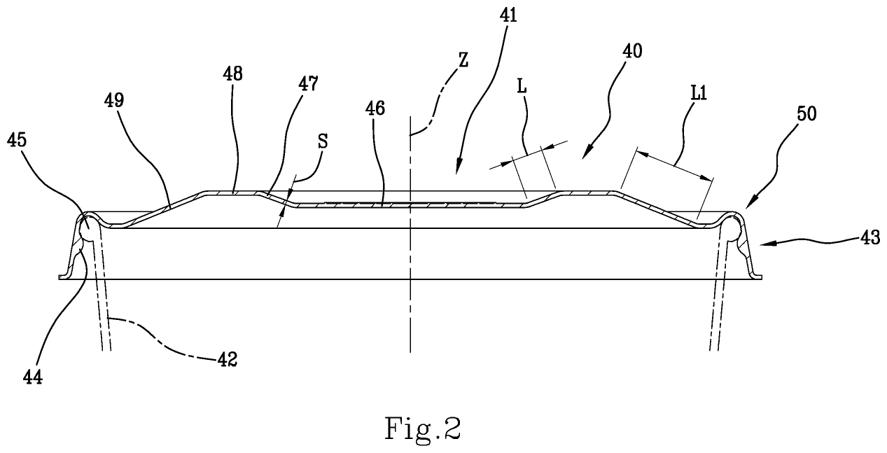

FIG. 2 is a cross-section showing a packaging component shaped like a lid for a container;

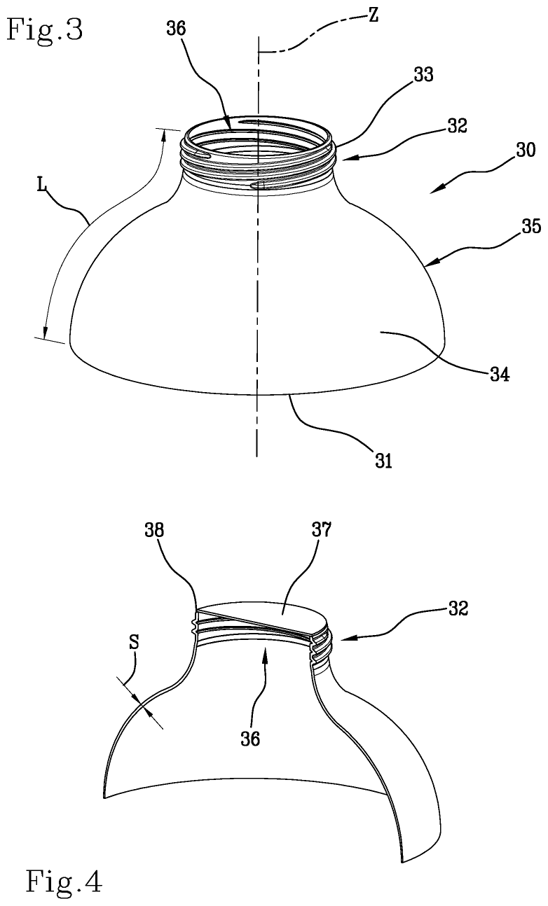

FIG. 3 is a perspective view showing a packaging component shaped like a neck for a container;

FIG. 4 is a perspective view, sectioned along a vertical plane, showing a packaging component shaped like a neck for a container according to an alternative embodiment;

FIG. 5 is a schematic cross-section, showing a mould for making a packaging component, in a first operating position;

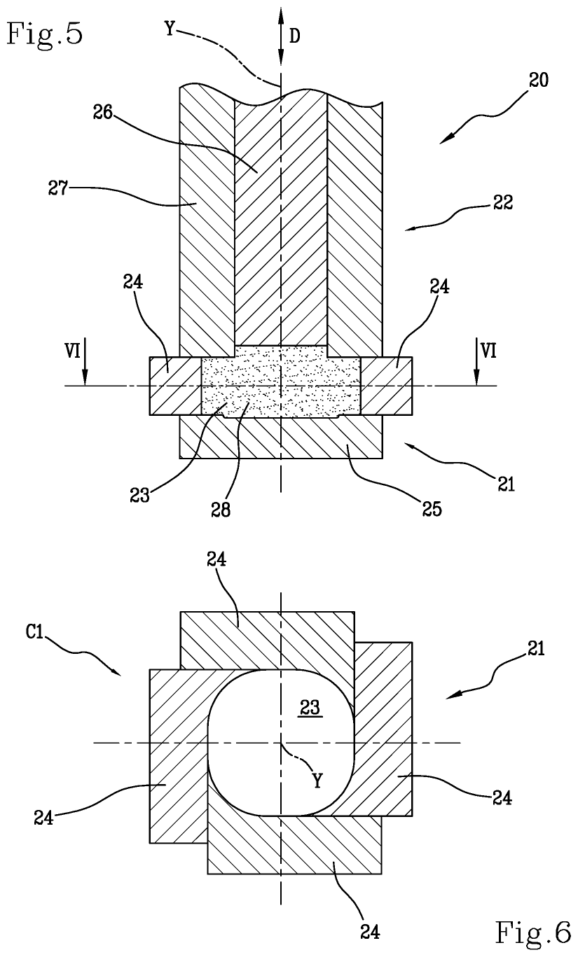

FIG. 6 is a cross-section of the mould of FIG. 5, along the plane VI-VI of FIG. 5;

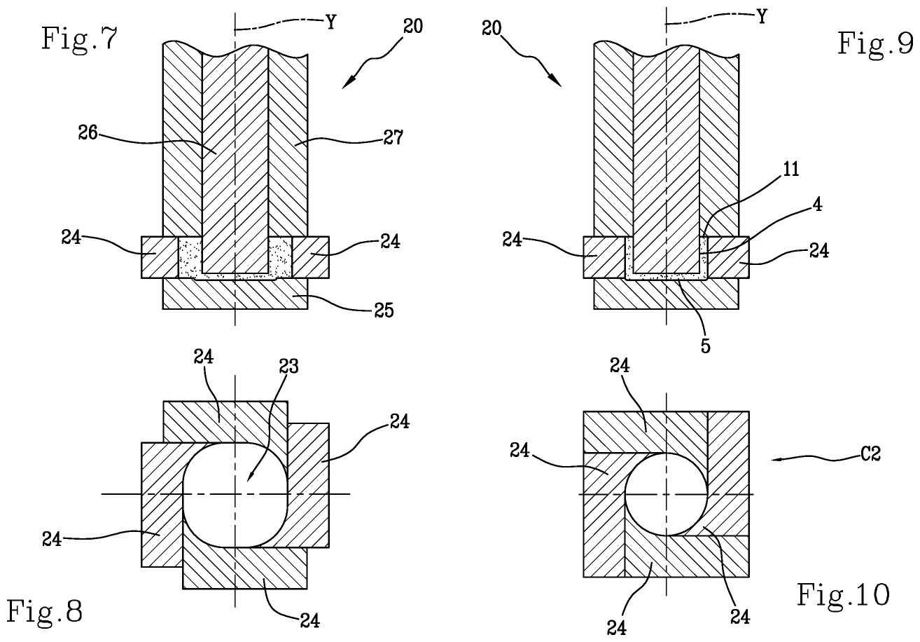

FIG. 7 is a cross-section like that of FIG. 5, showing a mould for making a packaging component, in a second operating position;

FIG. 8 is a cross-section like that of FIG. 6, showing the mould of FIG. 7;

FIG. 9 is a cross-section like that of FIG. 5, showing a mould for making a packaging component, in a third operating position;

FIG. 10 is a cross-section like that of FIG. 6, showing the mould of FIG. 9.

FIG. 1 shows a packaging component comprising a cap 1 intended to be applied to a container, for example a bottle, or a jar, or a pot or the like. The cap 1 is made with a material which comprises a significant percentage of cellulose, for example a quantity of cellulose greater than or equal to 80% by weight.

The material with which the cap 1 is made may also comprise additives such as dyes, adhesives, lubricants, substances intended to increase the density of the material comprising cellulose after the latter has been pressed, substances intended to improve particular properties of the cap 1, for example properties of a barrier to light or to gases. The additives may be present in a quantity less than or equal to 10% by weight.

The material with which the cap 1 is made may also comprise a limited quantity of synthetic polymeric material, for example less than or equal to 10% by weight.

The cap 1 comprises a cup-shaped body 2, inside which a cavity 3 is defined. Therefore, the cap 1 has a concave shape.

The cup-shaped body 2 comprises a first portion of wall, which in the example shown may be defined as an end wall or transversal wall 5.

The cup-shaped body 2 also comprises a second portion of wall or lateral wall 4, which extends around an axis Z. In the example shown, the lateral wall 4 has a substantially cylindrical shape.

The transversal wall 5 extends transversally, in particular perpendicularly, to the axis Z, at one end of the lateral wall. The end wall 5 may have a circular shape, if seen in plan view. The end wall 5 may be substantially flat, but this condition is not necessary.

An intended separating line 6 is provided on the lateral wall 4 to define an annular band 7 and a closing element 8. The closing element 8 comprises the end wall 5 and a skirt 9 which extends around the above-mentioned axis. The skirt 9 is joined to the end wall 5 in a joining zone 10. The skirt 9 is a portion of the lateral wall 4 interposed between the end wall 5 and the intended separating line 6.

The annular band 7 is a further portion of the lateral wall 4 and extends between the intended separating line 6 and a free edge 11 of the lateral wall 4.

The intended separating line 6 may be parallel to the free edge 11 of the lateral wall 4. More generally, the intended separating line 6 may extend in a plane perpendicular to the axis Z.

Before the cap 1 is applied on the neck of the container, the closing element 8 is joined to the annular band 7 along the intended separating line 6. When the cap 1 is opened for the first time, the closing element 8 separates from the annular band 7 along the intended separating line 6. The closing element 8 may be removed from the container and subsequently re-applied on the relative neck, whilst the annular band 7 remains anchored to the neck of the container after opening.

The intended separating line 6 may comprise a plurality of breakable elements 12, which are separated from each other by interrupting segments 13 at which material is not present. The interrupting segments 13 may be cut segments obtained by cutting the lateral wall 4 after the cup-shaped body 2 has been formed. In this way, a breakable element 12 remains defined between two consecutive cut segments. Alternatively, the interrupting segments 13 may be obtained while the cap 1 is formed, in the same mould in which the cap 1 is shaped.

The breakable elements 12 are intended to be broken the first time the closing element 8 is removed from the container to be brought into an open position.

The skirt 9 has at least one fixing element to allow the closing element 8 to be repeatedly fixed to the container and removed from the latter.

The fixing element has the shape of a projecting element which projects inwards towards the inside of the cup-shaped body 2, that is to say, towards the cavity 3. In the example shown, the fixing element is an inner screw thread 14 suitable for engaging with a corresponding thread made on the neck of the container.

There may be multiple fixing elements on the skirt 9, for example two or more inner screw threads 14. Alternatively, there may be a single fixing element on the skirt 9, for example a single inner screw thread 14. There may also be fixing elements which are not shaped like screw threads, for example shaped like parts of a cam or bayonet fixing elements.

The annular band 7 may comprise at least one engaging element 15 suitable for engaging with a retaining element provided on the container. The retaining element is intended to keep the annular band 7 anchored to the container, preventing the annular band 7 from being able to be separated from the container when the closing element 8 is removed. Each engaging element 15 is shaped like a projecting element which projects inwards towards the inside of the cup-shaped body 2 from the annular band 7.

However, other geometries of the engaging element 15 are possible. In the example shown, there are three engaging elements 15, but the number of engaging elements 15 may be selected according to the particular type of container and the features of the cap which must be applied to the container.

Made on the transversal wall 9 there is an annular seal 16 which projects towards the cavity 3, that is to say, inwards towards the inside of the cup-shaped body 2.

The annular seal 16 is suitable for engaging with the container, in particular with an edge region of the neck of the container, so that the closing element 8 can close the container in a substantially sealed manner. In the example shown, the annular seal 16 is suitable for penetrating inside the neck of the container to make contact with an inner surface of the neck. In an alternative embodiment not shown, the annular seal 16 could be dimensioned in such a way as to surround an edge of the neck of the container from the outside, so that it makes contact with an outer surface of the neck, near the rim of the latter.

There may also be more than one annular seal on the end wall 5.

The cap 1 may also comprise a plurality of gripping ribs 17, provided on an outer surface of the skirt 9 to allow a user to more securely grasp the closing element 8, reducing the risk that the closing element 8 will slip while the user is handling it. The gripping ribs 17 also improve the grip on the cap 1 on a capping machine.

The cap 1 is formed starting from a material containing cellulose, in the dry form (powder or granules or airlaid), or in the pasty form, or even in the form of a solid film or of a fluff. If the material used to form the cap is in the pasty form, it may be obtained by adding water or another liquid to a dry starting material.

The material containing cellulose is inserted into a mould comprising a male mould-part and a female mould-part and compacted between the male part and the female part, which are moved towards each other.

More specifically, a dose of material containing cellulose in a dry state can be inserted between the male part and the female part, arranged in an open or spaced apart position. At least one part chosen between the female part and the male part is then moved towards the other part chosen between the male part and the female part, in such a manner as to press the dose of material containing cellulose for obtaining the object.

The female part and/or the male part may comprise displaceable components which are movable to vary the volume of a forming chamber defined between the female part and the male part. The displaceable components may comprise one or more sectors, as will be better disclosed later, or may comprise an expandable elastomeric part.

In this way, the cup-shaped body 2 is obtained, by means of compression moulding.

The material containing cellulose has an initial density between 0.01 g/cm³ and 0.3 g/cm³, for example between 0.05 g/cm³ and 0.2 g/cm³. This material has therefore a relatively law initial density.

FIGS. 5 to 10 show an example of a mould 20 which can be used to obtain the cup-shaped body 2.

The mould 20 comprises a female mould-part 21 and a male mould-part 22, which are movable relative to each other along a moulding direction D parallel to a moulding axis Y.

The mould 20 has a forming region 23, in which the material containing cellulose is shaped to obtain the cup-shaped body 2. The forming region 23 has a volume which can be gradually reduced from the moment when the forming region 23 receives the material containing cellulose, until the moment when the cup-shaped body 2 is obtained. The forming region 23 is therefore a variable-volume forming region.

The female part 21 comprises a plurality of sectors 24, for example four sectors 24, suitable for defining a lateral surface of the forming region 23. Each sector 24 is in contact with two adjacent sectors 24.

The sectors 24 are slidable in contact with a transversal element 25 which defines a transversal surface of the forming region 23, that is to say, a surface of the forming region 23 which extends transversally to the moulding direction D.

In particular, the sectors 24 are slidable to pass from an initial position, shown in FIGS. 5 and 6, to a final position, shown in FIGS. 9 and 10. FIGS. 7 and 8 show an intermediate position which the sectors 24 reach between the initial position and the final position.

The sectors 24 can move under the action of one or more external actuators. In particular, each sector 24 can move because of the force applied to it by a respective external actuator and simultaneously because of the force applied to it by an adjacent sector 24.

The male part 22 comprises a punch 26, which extends along the moulding axis Y and is arranged to penetrate the forming region 23 so as to shape the cup-shaped body 2 from the inside.

Positioned on the outside of the punch 26 there is a tubular element 27, relative to which the punch 26 may be slidable.

A driving device not shown allows the female part 21 and the male part 22 to be moved relative to each other, so that the female part 21 and the male part 22 move towards each other to form the cup-shaped body 2 or alternatively they move away from each other to allow the cup-shaped body 2 formed to be removed from the mould 20.

During operation, the female part 21 and the male part 22 are initially located in a spaced apart or open position, in which a filling device not shown inserts into the forming region 23 the material containing cellulose which must be compressed in order to obtain the cup-shaped body 2.

The sectors 24 are arranged in the initial position, in which they define an expanded configuration C1 of the forming region 23. The sectors 24 therefore delimit a forming region 23 having a relatively large volume, which is capable of receiving a material containing cellulose having a relatively low density, which consequently occupies a lot of space.

The female part 21 and the male part 22 are moved towards each other until the tubular element 27 abuts against the sectors 24, as shown in FIG. 4. When that happens, between the female part 21 and the male part 22 a closed forming chamber 28 is defined, having a volume much greater than the final volume of the cup-shaped body 2.

The punch 26 is initially in a back position, in which it does not project from the tubular element 27, as shown in FIG. 4.

Then, the punch 26 penetrates the forming region 23 and moves towards the transversal element 25, until it is positioned at a distance from the transversal element 25 which is substantially equal to the thickness of the end wall 5 of the cap 1, as shown in FIGS. 6 and 7. The end wall 5 of the cap 1 is formed in this way.

The sectors 24, which until this moment were in the first position, corresponding to the expanded configuration C1 of the forming region 23, now begin to move towards each other. In this way the second position of the sectors 24 is reached, shown in FIGS. 8 and 9, corresponding to a final configuration C2 of the forming chamber 28. In this configuration, the sectors 24 are positioned at a distance from the punch 26 which corresponds to the thickness of the lateral wall 4 of the cup-shaped body 2. In this way, the lateral wall 4 is compressed, owing to the interaction between the sectors 24 and a lateral portion of the punch 26.

The free edge 11 of the lateral wall 4 is formed as a result of the interaction between the material comprising cellulose and a surface portion of the tubular element 27.

The cup-shaped body 2 formed in this way can now be extracted from the mould.

During pressing or compression moulding of the material comprising cellulose in the mould 20, pressures greater than 200 bar are applied to that material. The material comprising cellulose is heated until it reaches a temperature within the range 150-200° C. Heating of the material comprising cellulose may occur in the mould 20 and/or upstream of the latter, in such a way that the material comprising cellulose arrives in the mould 20 already at the desired temperature.

In an alternative embodiment, the mould 20 may pass from the initial position shown in FIGS. 5 and 6 to the final position shown in FIGS. 9 and 10 even by following a sequence of movements different from that described above, for example by moving the punch 26 towards the transversal element 25 before moving the sectors 24 or even simultaneously.

The mould 20 allows a high degree of compaction of the material comprising cellulose to be obtained. In particular, it is possible to obtain a cup-shaped body 2 having an average density which is greater than or equal to 0.8 g/cm³.

In one embodiment, the average density of the cup-shaped body 2 may be greater than or equal to 1 g/cm³.

It is also possible to obtain an average density of the cup-shaped body 2 greater than or equal to 1.1 g/cm³.

During moulding, the density of the material containing cellulose is increased by at least 2.5 times, for example by at least 80 times.

Owing to the movement of the sectors 24 towards the punch 26 and owing to the punch 26 and to the transversal element 25 which are movable towards each other, it is possible to perform a kind of isostatic pressing, in which the pressing force is applied to the material containing cellulose in a substantially uniform way in different directions.

That allows the obtainment of an average density greater than or equal to 0.8 g/cm³ (preferably greater than or equal to 1 g/cm³, or more preferably greater than or equal to 1.1 g/cm³) both in the end wall 3 and in the lateral wall 4 of the cup-shaped body 2.

The cup-shaped body 2, and the cap 1 obtained from it, consequently has good mechanical properties, in particular good mechanical strength. That makes it possible to also use the cap 1 to close containers in which substances having quite a high pressure are present.

In particular, the average density greater than or equal to 0.8 g/cm³ (preferably greater than or equal to 1 g/cm³, or more preferably greater than or equal to 1.1 g/cm³) can be obtained on the inner screw thread 14, by means of which the cap 1 can be removably fixed to the relative neck. That allows the obtainment of a stable and mechanically strong thread, which does not break or deform during application on the neck and subsequent removal.

The lateral wall 4 of the cap 1 has a thickness S and a length L. In the example shown, in which the lateral wall 4 extends substantially parallel to the axis Z, the length L of the lateral wall 4 coincides with the axial dimension of the lateral wall 4, that is to say, with the dimension of the lateral wall 4 along the axis Z. The length L is measured in a cross-section in a plane which contains the axis Z.

In one embodiment not shown, applicable not just to the cap 1 but also to other types of objects, the second portion of wall or lateral wall 4 could be inclined relative to the axis Z, for example forming an angle of less than or equal to 45° with the axis Z. In this case, the length L is defined in a longitudinal direction, that is to say, in a direction along which the second portion of wall or lateral wall 4 extends.

The thickness S can be calculated in a zone of the second portion of wall or lateral wall 4 which is free of threads, for example between two consecutive inner screw threads 14.

The ratio between the thickness S and the length L is less than or equal to 1. In one embodiment, the ratio between the thickness S and the length L is less than or equal to 0.5.

In the embodiment of FIG. 1 the second portion of wall is the lateral wall 4, that is to say, a peripheral wall of the cap 1, which extends in a peripheral region of the cap 1 so as to laterally delimit the cap 1.

As will be described in more detail below, it is also possible to have objects in which the second portion of wall is positioned in an inner region of the object.

The mould 20 may be used not just to make a cap 1, but also to make other concave objects, such as containers, or container necks. Even in the case of concave objects other than caps, it is possible to obtain an average density greater than or equal to 0.8 g/cm³ preferably greater than or equal to 1 g/cm³, or more preferably greater than or equal to 1.1 g/cm³) both in a first portion of wall, similar to the transversal wall 5, and in a second portion of wall, similar to the lateral wall 4, which surrounds the first portion of wall and extends around an axis.

The caps 1 or the concave objects comprising a quantity of cellulose equal to at least 80% by weight and having an average density greater than or equal to 0.8 g/cm³ (in particular both in the lateral wall and in the end wall) can be obtained either with a mould 20 of the type shown in FIGS. 5 to 10, or with a different type of mould, for example with a mould in which the sectors have a shape and/or a movement different from that of the sectors 24 shown in FIGS. 5 to 10, or with a mould having sectors which expand to form an inner surface of the desired object.

FIG. 3 shows another example of an object made with a material containing a quantity of cellulose equal to at least 80% by weight, which also has a concave structure, more specifically shaped like an upper part 30 of a container.

The upper part 30 comprises an edge zone 31 suitable for being fixed to a container body, for example to the lower part of a bottle. At an opposite end to the edge zone 31, the upper part 30 comprises a container neck 32 to which a cap, not shown, intended to close the container can be removably fixed.

The neck 32 extends around an axis Z.

The neck 32 may be provided with at least one outer screw thread 33, suitable for engaging with a corresponding thread made on the cap to allow the cap to removably engage with the neck 32.

Below the outer screw thread 33 there may be one or more annular protuberances, not shown.

Interposed between the neck 32 and the edge zone 31 there is a portion of container 34 which gradually widens from the neck 32 towards the edge zone 31.

The neck 32 and the portion di container 34 define a lateral wall 35 of the upper part 30 of the container.

The lateral wall 35 is a peripheral wall which laterally delimits the upper part 30 of the container.

The lateral wall 35 has a longitudinal dimension L, measured along the extent of the lateral wall 35. The lateral wall 35 also has a thickness S, more clearly shown in FIG. 4.

The ratio between the thickness S and the longitudinal dimension L is less than or equal to 1. That ratio may be less than or equal to 0.5.

The neck 32 surrounds a passage 36 through which the product contained in the container can be supplied.

In the embodiment shown in FIG. 4, the upper part 30 of the container comprises a membrane 37 which closes the passage 36. The membrane 37 is positioned near an upper edge 38 of the neck 32.

The membrane 37 can be removed before filling the container in which the upper part 30 is included. In this way, the container can be filled through the passage 36.

Alternatively, the membrane 37 can be removed by the user at the time of first opening of the container.

The membrane 37 is not essential and the upper part 30 of the container could even be formed without the membrane 37, as in the embodiment of FIG. 3.

The upper part 30 of the container may be formed in a mould of the type previously described, for example in a mould similar to that shown in FIGS. 5 to 10.

The upper part 30 of the container has a concave shape and may have an average density greater than 0.8 g/cm³ both in the lateral wall 35, in particular in the neck 32 and/or in the portion of container 34, and in its end or transversal wall, that is to say, in the membrane 37.

FIG. 2 shows a packaging component according to an alternative embodiment, comprising a lid 40 for a container such as a cup or a jar. As for the packaging components previously described, the lid 40 is made with a material which contains at least 80% by weight of cellulose. The material may contain up to 10% synthetic polymeric materials and/or up to 10% additives.

The lid 40 comprises a covering wall 41 or transversal wall positioned to close an upper opening of a container 42, shown with a dashed line in FIG. 2. The lid 40 also comprises an anchoring wall 43 or lateral wall, which has an annular projection 44 on its inner surface. The annular projection 44 is suitable for engaging, for example in a snap-on fashion, with a thickened edge 45 of the container 42, so that it is removably fixed to the container 42. The covering wall 41 and the anchoring wall 43 give the lid 40 a concave shape.

The covering wall 41 comprises a first portion of wall 46 and a second portion of wall 47, which surrounds the first portion of wall 46 and extends around an axis Z.

The first portion of wall 46 intersects the axis Z and is positioned transversally, in particular perpendicularly, to the axis Z. The first portion of 25 wall 46 may be flat and may have a shape in plan view which is for example circular. Projecting from the first portion of wall 46 is the second portion of wall 47, which has a substantially frustoconical shape.

The covering wall 41 also comprises an annular portion of wall 48, which surrounds the second portion of wall 47 and may extend perpendicularly to 30 the axis Z. A third portion of wall 49, having a frustoconical shape with opposite conicity to the first portion of wall 46 may extend from the annular portion of wall 47.

The third portion of wall 49 extends towards an angular zone 50 in which the covering wall 41 is joined to the anchoring wall 43.

The average density of the lid 40 is greater than or equal to 0.8 g/cm³, preferably greater than or equal to 1 g/cm³, even more preferably greater than or equal to 1.1 g/cm³.

The second portion of wall 47 has, in cross-section, a length L along its extension direction. The length L is measured in a cross-section of the lid 40 in a plane which contains the axis Z.

The second portion of wall 47 has a thickness S, which in the example shown is constant in the entire covering wall 41, even if this condition is not necessary.

The ratio between the thickness S and the length L of the second portion of wall 47 is less than or equal to 1. In one embodiment, the ratio between the thickness S and the length L1 of the third portion of wall 49 is less than or equal to 0.5.

The average density in the second portion of wall 47 is greater than or equal to 0.8 g/cm³, preferably greater than or equal to 1 g/cm³, even more preferably greater than or equal to 1.1 g/cm³.

The packaging component according to the invention therefore has a high average density, that is to say, of at least 0.8 g/cm³, even in the second portion of wall 47, which has a length significantly greater than the thickness and which projects from the first portion of wall 46.

Similar conditions are applicable for the ratio between the thickness S and the length L1 of the third portion of wall 49.

The lid 40 can be made with a mould similar to the mould 20 shown in FIGS. 5 to 10, or even with a different mould, for example without sectors. In the example in FIG. 2, the second portion of wall 47 is an inner portion of wall of the packaging component, that is to say, positioned in a non-peripheral region.

In general, the packaging component according to the invention, which has a cellulose content greater than or equal to 80% by weight and an average density greater than or equal to 0.8 g/cm³, can have a three-dimensional shape with a first portion of wall which extends transversally to an axis and a second portion of wall which extends around the axis.

In one embodiment, the ratio between the thickness of the second portion of wall and the length of the second portion of wall, measured along its extension direction, is less than or equal to 1, in particular less than or equal to 0.5.

Both the first portion of wall and the second portion of wall may have an average density value greater than or equal to 0.8 g/cm³.

In particular, the average density may be greater than or equal to 0.8 g/cm³, at the inner screw thread (or inner screw threads) 14 of the cap 1 or at the outer screw thread 33 of the neck 32, which allows the obtainment of good mechanical properties of the inner screw threads 14 and/or of the outer screw thread 33, in order to prevent them from deforming during use.

The density can be measured for example with one of the following methods:
mass/volume direct ratio if the volume is easily measurable;
hydrostatic scale;
pycnometer;
other.

It is also possible to have a packaging component, with a shape that is not concave, having average density values greater than 0.8 g/cm³ and made with a material comprising a minimum quantity of cellulose which is equal to 80% by weight. That component may have a shape which is substantially flat, that is that is to say, extend mainly in one plane, as in the case of a lid for a cup or more generally for any container.

In this case, it is possible to obtain a density greater than 0.8 g/cm³ even by forming the packaging component in a mould comprising two opposite parts, which are movable relative to each other, but without sectors similar to the sectors 24 previously described. The desired density values can be obtained by acting on the pressure and on the temperature applied to the packaging component during the forming step.

For example, it is possible to use a pressure greater than 200 bar and a temperature of between 150 and 200° C.

In this way it is possible to obtain objects made with a material having a low environmental impact, which have good mechanical properties.

In all of the components described above, at least 50-70% of the cellulose fibres contained in the material which forms those components may have a length within the range of 0.2-3.0 mm.

1. A moulded packaging component made with a material which contains a quantity of cellulose equal to at least 80% by weight, said moulded packaging component; having an average density greater than or equal to 0.8 g/cm³.

2. The moulded packaging component according to claim 1, wherein said material contains up to 10% synthetic polymers and/or up to 10% additives.

3. The moulded packaging component according to claim 1, comprising a first portion of wall and a second portion of wall which surrounds the first portion of wall and extends around an axis, the average density being greater than or equal to 0.8 g/cm³ both in the first portion of wall and in the second portion of wall.

4. The moulded packaging component according to claim 3, wherein the second portion of wall is arranged in an inner region of the moulded packaging component.

5. The moulded packaging component according to claim 3, wherein the second portion of wall is a lateral wall which extends in a peripheral region of the moulded packaging component so as to laterally delimit the moulded packaging component.

6. The moulded packaging component according to claim 3, wherein the second portion of wall has a thickness and a length, the length being measured in a plane which contains said axis, the ratio between the thickness and the length being less than or equal to 1.

7. The moulded packaging component according to claim 1, further comprising at least one screw thread for removably fixing the packaging component to a different packaging component, wherein the average density of said at least one screw thread is greater than or equal to 0.8 g/cm³.

8. The moulded packaging component according to claim 1, the moulded packaging component being shaped like a cap for a container.

9. The moulded packaging component according to claim 1, the moulded packaging component being shaped like a container.

10. The moulded packaging component according to claim 1, the moulded packaging component being shaped like a lid for a container.

11. The moulded packaging component according to claim 1, the moulded packaging component being shaped like an upper part of a container, the upper part comprising a container neck and an edge zone suitable for being joined to a lower part of a container.

12. The moulded packaging component according to claim 11, wherein the upper part of the container comprises a membrane which closes the neck and is positioned at an end of the upper part of the container opposite to the edge zone.

13. The moulded packaging component according to claim 1, wherein at least 50%, of the cellulose fibres contained in said material have a length within the range of 0.2-3.0 mm.

14. A method for obtaining a packaging component, comprising the steps of:
inserting a material containing cellulose into a mould;
pressing the material containing cellulose in the mould;
extracting from the mould the formed packaging component, said packaging component comprising a quantity of cellulose equal to at least 80% by weight and having an average density greater than or equal to 0.8 g/cm³.

15. The method according to claim 14, wherein the packaging component has a concave shape and comprises a lateral wall which extends around an axis and a transversal wall which extends transversally to the axis, the pressing step comprising applying to the material containing cellulose an axial pressure in a direction parallel to said axis by moving relative to each other two opposite mould parts to form the transversal wall, so as to obtain an average density greater than or equal to 0.8 g/cm³ in the transversal wall of the packaging component, the pressing step further comprising applying to the material containing cellulose a transversal pressure transversally to said axis by moving a plurality of sectors of the mould, the sectors forming a surface of the lateral wall, so as to obtain an average density greater than or equal to 0.8 g/cm³ in the lateral wall of the packaging component.

16. The method according to claim 14, wherein the packaging component comprises a first portion of wall and a second portion of wall which surrounds the first portion of wall and extends about an axis, the pressing step comprising applying to the material containing cellulose an axial pressure in a direction parallel to said axis by moving relative to each other two opposite mould parts to form the transversal wall, so as to obtain an average density greater than or equal to 0.8 g/cm³ in the first portion of wall of the packaging component, the pressing step further comprising applying to the material containing cellulose a transversal pressure transversally to said axis by moving at least one displaceable component of the mould, the displaceable component forming a surface of the second portion of wall, so as to obtain an average density greater than or equal to 0.8 g/cm³ in the second portion of wall of the packaging component.

17. The method according to claim 14, wherein the step of inserting a material containing cellulose into the mould comprises inserting into the mould a discrete and dosed quantity of material containing cellulose.

18. The method according to claim 17, wherein the discrete and dosed quantity of material containing cellulose is in a dry state.

19. The method according to claim 14, wherein the material containing cellulose which is inserted into the mould has a density comprised between 0.01 g/cm³ and 0.3 g/cm³ before the pressing step.

20. (canceled)

21. The moulded packaging component according to claim 6, wherein the ratio between the thickness and the length is less than or equal to 0.5.
